(19) United States
(12) Patent Application Publication
(10) Pub. No.: US 2007/0120822 A1
(43) Pub. Date: May 31, 2007

(54) Information processing apparatus and change-over method

(75) Inventor: Kageyuki Iso, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/605,332

(22) Filed: Nov. 29, 2006

(30) Foreign Application Priority Data
Nov. 30, 2005 (JP) 2005-346923

(51) Int. Cl. G09G 5/00

(52) U.S. Cl. 345/156

(57) ABSTRACT

To enable change over in a plurality of display patterns of virtual input section such as a virtual key board for increasing usability. An information processing apparatus includes, at user's hands, a virtual input section display unit for displaying an input section of the virtual key board or the like (for example, a virtual key board irradiation section), a detection unit for detecting a position where the user performed a touch operation on the input section (a touch operation position detecting sensor), a determination unit for determining the input position of the input section on which the user performs the touch operation on the basis of data detected by the detection unit, (an EC/KBC), and a change-over unit for changing a display pattern of the input section in a plurality of types from the first display pattern to the n-th display pattern (a CPU, a ROM, and a SW).

### CROSS-REFERENCE TO RELATED APPLICATIONS

This application claims the benefit of priority of Japanese Patent Application No. 2005-346923, filed Nov. 30, 2005, the entire contents of which are incorporated herein by reference.

### BACKGROUND

1. Field

The present invention relates to an information processing apparatus for virtually displaying an input section such as a key board at user.'s hands. More particularly, the invention relates to an information processing apparatus and a change-over method for changing over a display pattern of the input section in a plurality of patterns.

2. Description of the Related Art

As disclosed in JP-A 2000-89899, there is an information processing apparatus such as a PDA (Personal Digital Assistant) in which an image of a so-called virtual key board is projected from an apparatus main body to outside, movement of a finger of a user who operates this virtual key board, a pen, or the like is optically detected from the apparatus main body, and the information is input a central processing unit (CPU).

In this way, the image of the virtual key board is projected from the apparatus main body to outside to allow the user to perform operation, whereby both miniaturization of the apparatus main body and increase in the key board operation area can be achieved. Thus, it is possible to provide an information processing apparatus which is convenient for carrying and also easy to use. However, a further improvement is being demanded.

### SUMMARY OF THE INVENTION

Accordingly, the present invention has been made to further improve the above-mentioned invention and it is therefore an object of the present invention to provide an information processing apparatus and a change-over method with which a display pattern of a virtual input section such as a virtual key board can be changed over in a plurality of display patters to enhance convenience.

To achieve the above-mentioned object, an information processing apparatus according to an aspect of the present invention includes display means for displaying an input section, and change-over means for changing a display pattern of the input section from a first display pattern to a second display pattern.

In addition, a change-over method according to another aspect of the present invention includes displaying an input section, and changing a display pattern of the input section from a first display pattern to a second display pattern.

According to the present invention, the display pattern of a virtual input section such as a virtual key board can be changed over in a plurality of patterns, thereby enhancing the convenience.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a personal computer according to an embodiment of the present invention.

FIG. 2 is a plan view showing a method of detecting a touch operation position with use of an optical detection section.

FIG. 3 is a plan view showing the method of detecting the touch operation position with use of the optical detection section.

FIG. 4 is a block diagram of a control system of the personal computer and a flow of information.

FIG. 5 is a plan view showing a key board based on a QWERTY arrangement.

FIG. 6 is a plan view showing a key board based on an AZERTY arrangement.

FIG. 7 is a plan view showing a key board based on a Japanese kana (JIS: Japanese Industrial Standards) arrangement.

FIG. 8 is a flowchart of a control flow according to the embodiment of the present invention.

FIG. 9 shows an example of a selection image for selecting a layout of a virtual key board.

### DETAILED DESCRIPTION

Hereinafter, embodiments of the present invention will be described with reference to drawings.

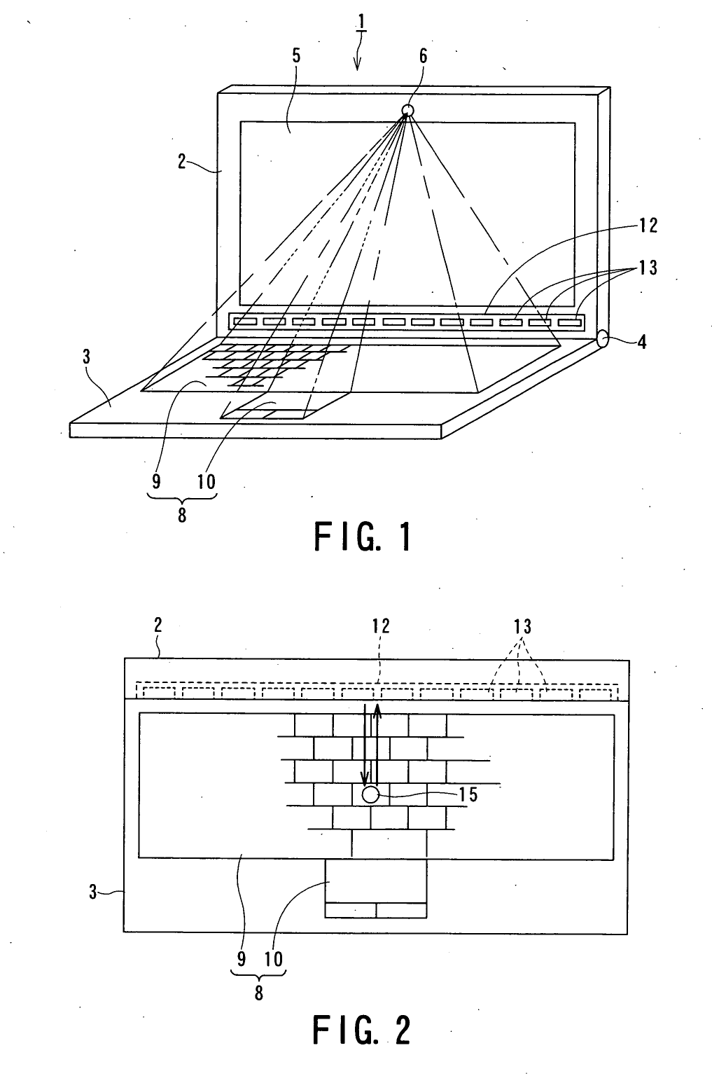

FIG. 1 is a perspective view of a personal computer, showing an example of an information processing apparatus to which an embodiment of the present invention is applied.

In this personal computer, which is denoted by reference numeral 1, a main body 2 and a display board 3 are connected to each other via a hinge portion 4 so as to be closed and opened. When the personal computer 1 is used, the display board 3 is placed on a desk or the like, and the main body 2 is put in a state of being opened upward.

When the main body 2 is in an opened state, a liquid crystal display panel (LCD) 5 exists on the front side of the main body 2, and an upper part of the liquid crystal display panel 5 is provided with one or a plurality of virtual key board irradiation sections 6 (display means). The virtual key board irradiation section 6 displays a virtual key board 8 (input section) at user's hands, that is in this case, on an upper surface of the display board 3 by projecting an image with use of laser beam, for example. It should be noted that for instance, without provision of the display board 3 or by employing a detachable construction, the virtual key board 8 may be directly projected on a desk or a wall surface from the virtual key board irradiation section 6.

The virtual key board 8 is configured to include at least one of a key input section 9 and a pointer control section 10. In the case where the pointer control section 10 is displayed, the display position can be set arbitrarily, for example, at a position on one of right and left sides or one of upper or lower side of the key input section 9. Furthermore, the pointer control section 10 can be displayed only when it is necessary and can be turned off when it is unnecessary.

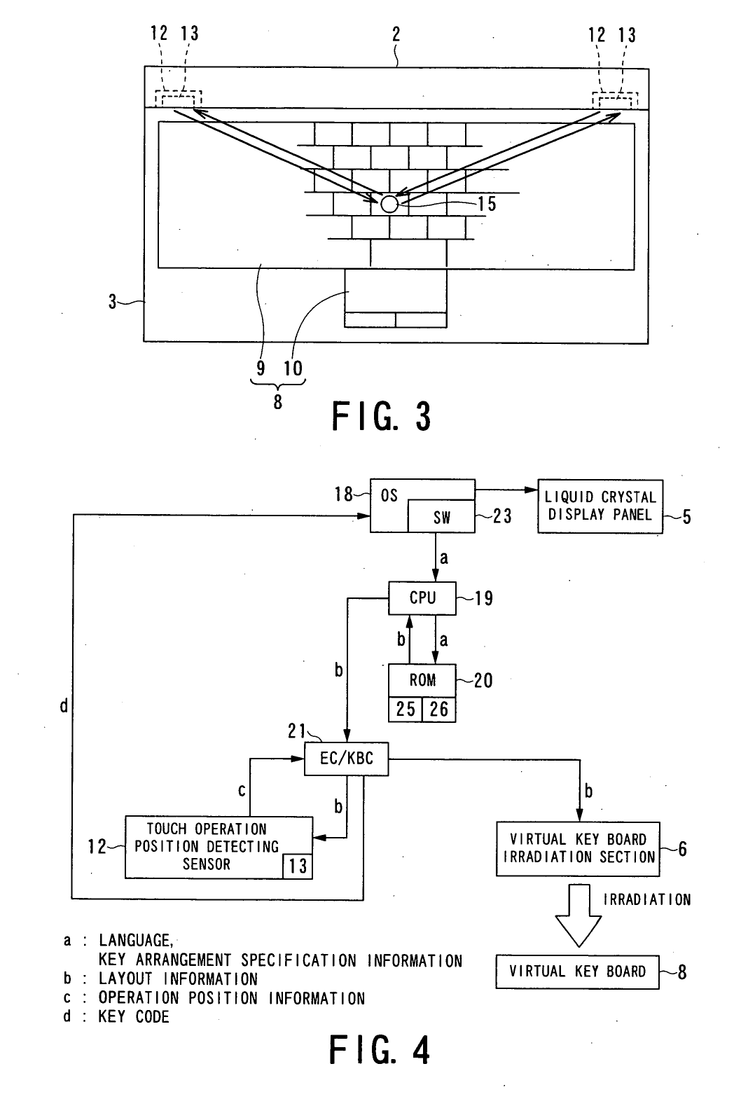

A touch operation position detecting sensor 12 (detection means) is provided on a front side of the main body 2, which is located on a lower side of the liquid crystal display panel 5. The touch operation position detecting sensor 12 is adapted to remotely detect a touch operation position of the user who performs a touch operation on the virtual key board 8 by using a finger, a pen, or the like. For example, the touch operation position detecting sensor 12 includes one or a plurality of optical detection sections 13 (detection sections). As shown in FIG. 2 or 3, the optical detection section 13 optically detects an input position 15 of a finger of the user who performs a touch operation on the virtual key board 8, a pen, or the like, with use of a laser beam, an infrared light, etc. As a result, the optical detection section 13 precisely detects which key is subjected to the touch operation on the virtual key board 8.

FIG. 4 is a block diagram showing a control system of the personal computer 1 and a flow of information. The personal computer 1 includes an OS (Operating System) 18 which is basic software, a CPU (Central Processing Unit) 19, a ROM (Read Only Memory) 20, an EC/KBC (Embedded Controller/Key Board Controller) 21 (determination means) functioning as a control section of the virtual key board 8. A BIOS (Basic Input Output System), for example, is preferably stored in the ROM 20.

The liquid crystal display panel 5 is controlled by the OS 18. The virtual key board irradiation section 6 and the touch operation position detecting sensor 12 are controlled by the EC/KBC 21. Then, the CPU 19, the ROM 20, and a changing-over switch (SW) 23 accommodated in the OS 18 constitute change-over means. The EC/KBC 21 functioning as the determination means receives information input from the touch operation position detecting sensor 12 to determine the input position where the user performs the touch operation in the virtual key board 8 (the key input section 9 and the pointer control section 10).

The CPU 19, the ROM 20, and the SW 23 functioning as the change-over means can change the display pattern of the virtual key board 8 in a plurality of display patterns from the first display pattern to the n-th display pattern.

For example, the ROM 20 includes a language change-over function section 25 and a key arrangement format change-over function section 26.

The language change-over function section 25 (change-over means for change over a key layout in accordance with a language) changes a key layout of the key input section 9 in accordance with a plurality of languages from the first key layout corresponding to the first language to the n-th key layout corresponding to the n-th language.

On the other hand, the key arrangement format change-over function section 26 (change-over means for change over a key layout in accordance with a key arrangement format) changes the key layout of the key input section 9 in accordance with a plurality of key arrangement formats from the first key layout corresponding to the first key arrangement format to the n-th key layout corresponding to the n-th key arrangement format.

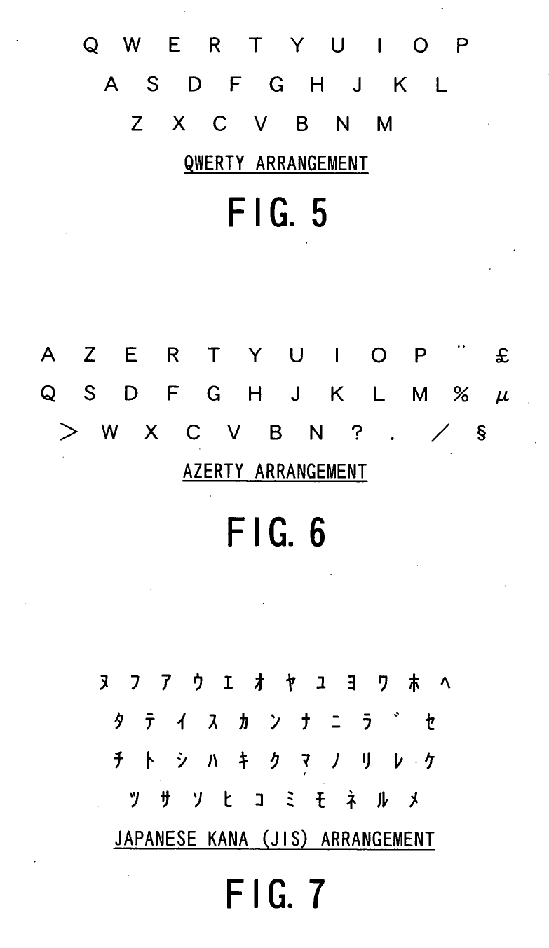

The language change-over function section 25 stores a plurality of key board arrangements corresponding to the respective languages, for example, Japanese, English, German, French, Russian, Chinese, and Korean. On the other hand, the key arrangement format change-over function section 26 stores a plurality of key board arrangements corresponding to various key arrangement formats, for example, a QWERTY arrangement (refer to FIG. 5), an AZERTY arrangement (refer to FIG. 6), and a Japanese kana, i.e. Japanese characters, (JIS: Japanese Industrial Standards) arrangement (refer to FIG. 7). These key board arrangements are selected as necessary and combined with each other, whereby the result is displayed as the virtual key board 8 (the key input section 9). It should be noted that it is possible to appropriately virtually display any kind of possible key board arrangements, touch pad formats, and software such as CAD by being stored in the ROM 20.

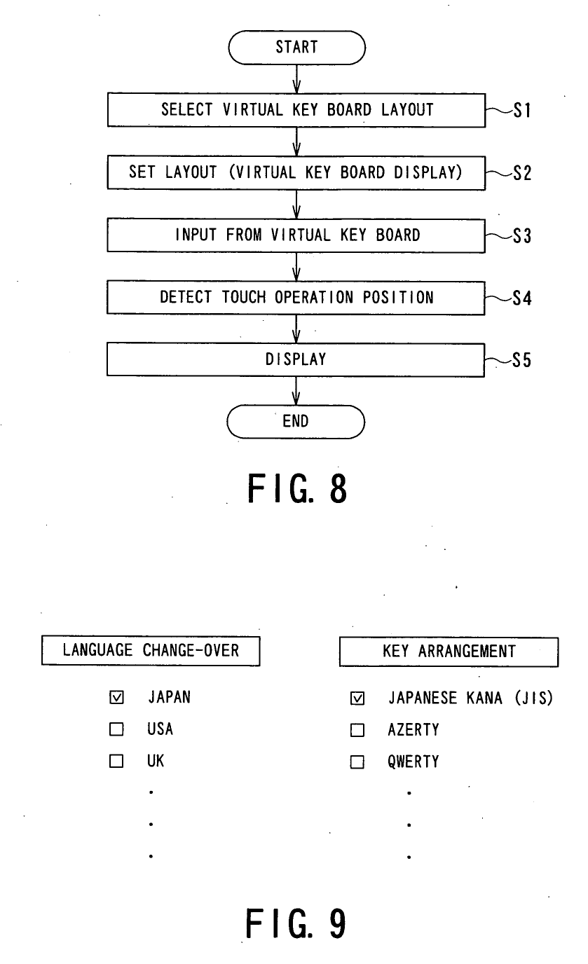

FIG. 8 is a flowchart showing a flow for creating documents or the like with use of the personal computer 1. The flowchart shows processes from type selection of the virtual key board 8 and input by the user to completion of the display on the liquid crystal display panel 5.

First of all, in Step S, by using the changing-over switch (SW) 23 of the OS 18, the layout of the virtual key board 8 is selected. At this time, the liquid crystal display panel 5 displays a selection screen (utility screen) as shown in FIG. 9. The user then selects a language and a key arrangement of the virtual key board 8 through input from a mouse or the like. At this moment, information “a” (refer to FIG.4) for specifying the language and the key arrangement is input to the ROM 20 from the changing-over switch (SW) 23 via the CPU 19.

Next, in Step S2, the CPU 19 selects the key board arrangement selected by the user in Step S1 among the plurality of the key board arrangements stored in the language change-over function section 25 and the key arrangement format change-over function section 26 in the ROM 20, thereby outputting layout information “b” (refer to FIG.4) to the EC/KBC 21. The layout information “b” is output via the EC/KBC 21 to the virtual key board irradiation section 6 and also to the touch operation position detecting sensor 12. The layout information “b” functions in accordance with the key board arrangements to which the virtual key board irradiation section 6 and the touch operation position detecting sensor 12 are set. Then, the virtual key board irradiation section 6 irradiates and displays the virtual key board 8 on the upper surface of the display board 3.

In Step S3, the user inputs typing, drawings, and the like with use of the virtual key board 8. After that, in Step S4, while the touch operation position detecting sensor 12 (the optical detection section 13) is used, the touch operation position of the user who performs a touch operation on the virtual key board 8 by using a finger, a pen, or the like is remotely detected. Then, information “c” (refer to FIG.4) on the operated position is fed back to the EC/KBC 21.

Furthermore, in Step S5, on the basis of the operated position information “c” fed back from the touch operation position detecting sensor 12, the EC/KBC 21 outputs key code information “d” (refer to FIG.4) to the OS 18. The OS 18 displays the content inputted from the user on the liquid crystal display panel 5, and the control is completed.

As described above, the key layout of the virtual key board 8 is changed over in accordance with the plurality of languages and key arrangement formats, whereby it is possible to cope with a variety of languages and the like with only use of one personal computer 1 and also possible to significantly increase the usability of the personal computer. It should be noted that the present invention can be widely applied not only to the personal computer but also to other various electronic devices such as a word processor, an appointment organizer, a computerized dictionary, and electric computer.

What is claimed is:

1. An information processing apparatus, comprising:
display means for displaying an input section; and
change-over means for changing a display pattern of the input section from a first display pattern to a second display pattern.

2. The information processing apparatus according to claim 1, wherein:
the input section includes a key input section; and
the change-over means includes switch means for changing a key layout of the key input section from a first key layout corresponding to a first language to a second key layout corresponding to a second language.

3. The information processing apparatus according to claim 1, wherein:
the input section includes a key input section; and
the change-over means includes switch means for changing a key layout of the key input section from a first key layout corresponding to a first key arrangement to a second key layout corresponding to a second key arrangement.

4. The information processing apparatus according to claim 1, wherein the input section includes a pointer control section.

5. The information processing apparatus according to claim 1, further comprising:
detection means for detecting a position where a user performs a touch operation on the input section; and
determination means for determining the position where the user performs the touch operation on the input section on the basis of data detected by the detection means.

6. The information processing apparatus according to claim 5, wherein the detection means includes a detection section for optically detecting the position where the user performs the touch operation.

7. A change-over method, comprising:
displaying an input section; and
changing a display pattern of the input section from a first display pattern to a second display pattern.

8. The change-over method according to claim 7, wherein:
the input section includes a key input section; and
a key layout of the key input section is changed from a first key layout corresponding to a first language to a second key layout corresponding to a second language.

9. The change-over method according to claim 7, wherein:
the input section includes a key input section; and
a key layout of the key input section is changed from a first key layout corresponding to a first key arrangement to a second key layout corresponding to a second key arrangement.
